(19) United States
(12) Patent Application Publication
(10) Pub. No.: US 2010/0217667 A1
(43) Pub. Date: Aug. 26, 2010

(54) INTERNET SEARCH ENGINE AFFILIATE SYSTEM AND METHOD

(75) Inventor: Yeong Il Mo, Seoul (KR)

Correspondence Address: CARTER, DELUCA, FARRELL & SCHMIDT, LLP, 445 BROAD HOLLOW ROAD, SUITE 420, MELVILLE, NY, 11747, US

(73) Assignee: G&G Commerce Ltd., Seoul (KR)

(21) Appl. No.: 12/556,259

(22) Filed: Sep. 9, 2009

(30) Foreign Application Priority Data
Feb. 24, 2009 (KR) 10-2009-0015238

(51) Int. Cl. G06Q 30/00; G06F 3/048; G09G 5/00; G06F 17/30

(52) U.S. Cl. 705/14.51; 705/14.69; 705/26; 715/760; 345/619; 707/E17.001

(57) ABSTRACT

Disclosed herein is an Internet search engine affiliate system and method. The system includes a merchant site server, at least one affiliate application provider server for distributing at least one application for performing an affiliate advertising function for merchandise to at least one application distributor terminal, and, when the application distributor terminal receives a search request signal for merchandise registered on the merchant site from at least one buyer terminal, sending search result merchandise information to the buyer terminal, the application distributor terminal for executing the distributed application, sending information about the merchandise registered on the merchant site to the buyer terminal, and receiving the search request signal for the merchandise from the buyer terminal, the buyer terminal for receiving and displaying the information about the merchandise, and the Internet for connecting the merchant site server, the affiliate application provider server and the application distributor terminal to each other.

### BACKGROUND OF THE DISCLOSURE

1. Field of the Disclosure

The present disclosure relates generally to an Internet search engine affiliate system and method, and, more particularly, to an Internet search engine affiliate system and method in which a merchant site or an affiliate application provider supplies a specific application program to affiliates and the affiliates advertise the application program to merchandise buyers, so that the merchant site can increase the amount of merchandise sold, and so that the affiliate program provider or the affiliates who advertise the application program receive part of the revenue in reward for affiliate advertising from the merchant site, thereby creating revenue.

2. Description of the Related Art

Currently, merchant sites, such as EBay and Google, allow normal netizens to perform affiliate merchandise sales or introduce Cost Per Click (CPC) advertisements to other persons through affiliate programs and to pay the netizens part of the sales revenue of the merchant sites.

As an example, in the case of EBay, when a merchandise buyer buys merchandise within 7 days after he or she viewed an affiliate advertisement posted by an affiliate, EBay pays the affiliate 50%˜75% of EBay sales commission. Meanwhile, when a merchandise buyer newly subscribes to EBay, EBay pays a relevant affiliate 1˜50 dollars depending on the degree of contribution of the new merchandise buyer.

In FIG. 1, revenue payment rates that were set by EBay on the basis of sales commission are shown. In FIG. 2, a profit payment policy for Google AdSense affiliates is shown.

Google pays affiliates part of the revenue in reward for keyword advertising through the affiliate program ‘AdSense’. AdSense is a program that automatically selects and posts an advertisement, registered by an advertiser and related to the content of a page, on a homepage, a blog or a community, operated by an affiliate, in the form of an image banner, a text advertisement or a search box advertisement. For this purpose, part of the advertising commission paid by an advertiser is paid to an affiliate in a cost per click (CPC) or cost per thousand impression (CPM) basis. Within 30 days from the last day of the month in which revenue reaches US 100 dollars, part of the advertising commission is paid by check or via Electronic Fund Transfer (EFT).

However, up to now, all affiliates related to the merchant site have performed only direct affiliate advertising functions through their own cybercafes, their own websites or their applications. There has been no system in which affiliate application providers provide an integrated affiliate advertising service between a merchant site, such as EBay or Google, and affiliates.

In particular, there has been no Internet search engine affiliate system in which additional revenue can be created in such a way that affiliate application providers receive advertising commission from a merchandise seller who requests a paid advertisement from an application program.

Furthermore, there has been no Internet search engine affiliate system that enables merchandise to be easily bought in such a way that the merchandise information of a merchant site is embodied through an application in the form of an image, the image is provided to merchandise buyers, and the merchandise buyers search for the merchandise using the provided image as a merchandise search condition, thereby enabling the merchandise to be easily bought.

### SUMMARY OF THE DISCLOSURE

Accordingly, the present disclosure has been made keeping in mind the above problems occurring in the prior art, and an object of the present disclosure is to provide an Internet search engine affiliate system and method in which an affiliate application provider supplies a specific application program to affiliates and the affiliates advertise the application program to merchandise buyers, so that a merchant site, the affiliate application provider and the affiliates, which are related to the system, can create fair revenue.

Another object of the present disclosure is to provide an Internet search engine affiliate system and method in which an affiliate application provider receives advertising commission from a merchandise seller who requests a paid advertisement from the application program, thereby creating additional revenue.

In order to accomplish the above objects, the present disclosure provides an Internet search engine affiliate system, including a merchant site server, the merchant site server being a server of a merchant site including a product sales website for providing an online space for sales or buying of one or more products over an Internet and an information sales website for providing paid information or at least one paid advertisement, the merchant site server being provided with a database storing merchandise information of the merchant site; at least one affiliate application provider server for distributing at least one application, that is, software for performing an affiliate advertising function for merchandise, to at least one application distributor terminal over the Internet, and, when the application distributor terminal receives a search request signal for merchandise registered on the merchant site from at least one buyer terminal through the application, sending search result merchandise information in response to the search request signal to the buyer terminal through the application; the application distributor terminal for executing the distributed application, sending information about the merchandise registered on the merchant site to the buyer terminal over the Internet, and receiving the search request signal for the merchandise registered on the merchant site from the buyer terminal through the application; the buyer terminal for receiving and displaying the information about the merchandise registered on the merchant site; and the Internet for connecting the merchant site server, the affiliate application provider server and the application distributor terminal to each other.

The Internet search engine affiliate system can further include at least one seller terminal for sending a merchandise registration request signal including merchandise information to be sold on the merchant site to the merchant site server.

The affiliate application provider server can have a function of receiving a merchandise link request signal for merchandise for affiliate advertising from the application distributor terminal and linking the merchandise for which the merchandise link request signal has been received to corresponding merchandise registered on the merchant site.

The affiliate application provider server can have a function of receiving related information of the merchandise for which the merchandise link request signal has been received from the merchant site server, creating a link image that embodies features of the merchandise using the received related information, and sending the created link image to the application distributor terminal.

The affiliate application provider server can have a function of, when a signal requesting a change of the link image is received from the application distributor terminal, creating a complete image obtained by changing the link image and sending the complete image to the application distributor terminal.

The affiliate application provider server can have a function of sending at least one recommended image similar to the created link image to the application distributor terminal.

The affiliate application provider server can have a function of, when appearance information of the merchandise for which the merchandise link request signal has been received does not exist in the affiliate application provider server, sending previously prepared link image creation information for the merchandise for which the merchandise link request signal has been received to the application distributor terminal; and the application distributor terminal has a function of creating a link image using the received link image creation information and sending the created link image to the affiliate application provider server.

The related information can include one or more of appearance information (an outline), auxiliary information, a feature demarcation line, a texture, a pattern, color and brand information of the merchandise.

The application distributor terminal can have a function of linking the merchandise for affiliate advertising to corresponding merchandise registered on a website, other than the merchant site, and the application.

The affiliate application provider server can have a function of, when the application distributor terminal performs linking to the merchandise registered on the website, other than the merchant site, sending a payment request signal to the application distributor terminal.

The application distributor terminal can have a function of causing the application, run by the application distributor terminal, to display only information about merchandise for which the application distributor terminal performs affiliate sales or advertising on the buyer terminal.

The affiliate application provider server can have a function of storing standard pattern data for merchandise and classifying feature points of the merchandise for which the merchant site server has received a merchandise registration request signal as a standard pattern by comparing feature points of a pattern of the merchandise with the standard pattern data.

The buyer terminal can have a function of storing merchandise information or merchandise searching image information; and the affiliate application provider server has a function, when the seller terminal sends a merchandise registration request signal for merchandise identical or similar to that of the merchandise information or merchandise searching image information stored by the buyer terminal, sending a notice message to the buyer terminal and a text message to the buyer's mobile phone.

The affiliate application provider server can have a function of sending and displaying information about the linked merchandise to and on the buyer terminal in webpage form, and, when a signal requesting exposure of the merchandise information at a specific location of the webpage is received from the application distributor terminal, exposing the merchandise information at the specific location of the webpage.

The merchant site server or affiliate application provider server can have a function of sending and displaying information about the linked merchandise to and on the buyer terminal in webpage form, and, when a similar merchandise search request signal for the linked merchandise is received from the buyer terminal, sending and displaying a complete image and its similar image used for the linking of the merchandise to and on the buyer terminal.

The merchant site server or the affiliate application provider server can have a function of, when it receives a similar merchandise search request signal using the displayed complete image or its similar image as a search condition from the buyer terminal, sending and displaying merchandise information of the displayed complete image or its similar image to and on the buyer terminal.

The merchant site server or the affiliate application provider server can have a function of changing one or more of appearance information (an outline), auxiliary information, a feature demarcation line, a texture, a pattern, a color and brand information of the displayed complete image or its similar image in order to search for new merchandise information by changing the displayed complete image or its similar image.

The merchant site server can have a function of, when the buyer terminal sends a buying request signal for merchandise to the merchant site server through the application, sending a sales commission deposit signal to the affiliate application provider server or a specific application distributor terminal.

The merchant site server can have a function of, when the buyer terminal sends a buying request signal for merchandise to the merchant site server through the application, determining whether to send a sales commission deposit signal to the affiliate application provider server or a specific application distributor terminal depending on which affiliate ID of the merchant site has been assigned to the merchandise for which buying has been requested.

The merchant site server can have a function of, when the buyer terminal sends a buying request signal for merchandise to the merchant site server through the application, determining whether to send a sales commission deposit signal to the affiliate application provider server or a specific application distributor terminal, and identifying the affiliate application provider server or application distributor terminal to which the merchant site server will send the sales commission deposit signal using a code on an affiliate program assigned to the merchandise by the affiliate application provider server.

The merchant site server can have a function of randomly assigning affiliate IDs of the merchant site to the merchandise the buying of which has been requested at predetermined percentages of the number of times the buyer terminal has attempted merchandise searching using the application.

In order to accomplish the above objects, the present disclosure provides an Internet search engine affiliate method using an Internet search engine affiliate system including a merchant site server, the merchant site server being a server of a merchant site including a product sales website for providing an online space for sales or buying of one or more products over an Internet and an information sales website for providing paid information or at least one paid advertisement, at least one affiliate application provider server for distributing at least one application, that is, software for performing an affiliate advertising function for merchandise, to at least one application distributor terminal over the Internet, the application distributor terminal for executing the distributed application and sending information about the merchandise registered on the merchant site to the buyer terminal over the Internet, the buyer terminal for displaying the received merchandise information, at least one seller terminal for sending a merchandise registration request signal including information about merchandise to be sold on the merchant site to the merchant site, and the Internet for connecting the merchant site server, the affiliate application provider server, the application distributor terminal and the seller terminal to each other, the method including the steps of (a) the affiliate application provider server receiving a search request signal for merchandise registered on the merchant site from the application distributor terminal through the application; (b) the affiliate application provider server sending search result merchandise information to the application distributor terminal through the application; (c) the affiliate application provider server receiving a merchandise link request signal for specific merchandise from the application distributor terminal, and linking merchandise for which a merchandise link request signal has been received to corresponding merchandise registered on the merchant site; and (d) the affiliate application provider server sending information about the linked merchandise to the buyer terminal.

Step (c) can include the step (c1) of the affiliate application provider server receiving from the merchant site server related information of the merchandise for which the merchandise link request signal has been received, creating a link image that embodies features of the merchandise using the received related information, and sending the created link image to the application distributor terminal.

Step (c) can include, after the step (c1), the step (c2) of the affiliate application provider server, when a signal requesting a change of the link image is received from the application distributor terminal, creating a complete image obtained by changing the link image and sending the complete image to the application distributor terminal.

Step (c1) can include the step (c3) of the affiliate application provider server sending at least one recommended image similar to the created link image, together with the created link image, to the application distributor terminal.

Step (c1) can include the step (c4) of the affiliate application provider server, when appearance information of the merchandise for which the merchandise link request signal has been received does not exist in the affiliate application provider server, sending previously prepared link image creation information for the merchandise for which the merchandise link request signal has been received to the application distributor terminal; and the step (c5) of the application distributor terminal creating a link image using the received link image creation information and sending the created link image to the affiliate application provider server.

In order to accomplish the above objects, the present disclosure provides an Internet search engine affiliate system, including at least one affiliate application provider server, the affiliate application provider server functioning as a server of a merchant site including a product sales website for providing an online space for sales or buying of one or more products over an Internet and an information sales website for providing paid information or at least one paid advertisement, the affiliate application provider server being provided with a database storing merchandise information of the merchant site, and the affiliate application provider server distributing at least one application, that is, software for performing an affiliate advertising function for merchandise, to at least one application distributor terminal over the Internet, and, when the application distributor terminal receives a search request signal for merchandise registered on the merchant site from at least one buyer terminal through the application, sending search result merchandise information in response to the search request signal to the buyer terminal through the application; the buyer terminal for sending a search request signal for the merchandise registered on the merchant site to the affiliate application provider server through the application, and receiving and displaying search result merchandise information; and the Internet for connecting the affiliate application provider server and the buyer terminal to each other.

In order to accomplish the above objects, the present disclosure provides an Internet search engine affiliate system, including a merchant site server, the merchant site server being a server of a merchant site including a product sales website for providing an online space for sales or buying of one or more products over an Internet and an information sales website for providing paid information or at least one paid advertisement, the merchant site server being provided with a database storing merchandise information of the merchant site; at least one affiliate application provider server for distributing at least one application, that is, software for performing an affiliate advertising function for merchandise, to at least one application distributor terminal over the Internet, and, when a search request signal for merchandise registered on the merchant site is received from at least one buyer terminal through the application, sending search result merchandise information in response to the search request signal to the buyer terminal through the application; the buyer terminal for sending a search request signal for the merchandise registered on the merchant site to the affiliate application provider server through the application, and receiving and displaying search result merchandise information; and the Internet for connecting the merchant site server, the affiliate application provider server and the buyer terminal to each other.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram showing revenue payment rates that were set by EBay on the basis of sales commission;

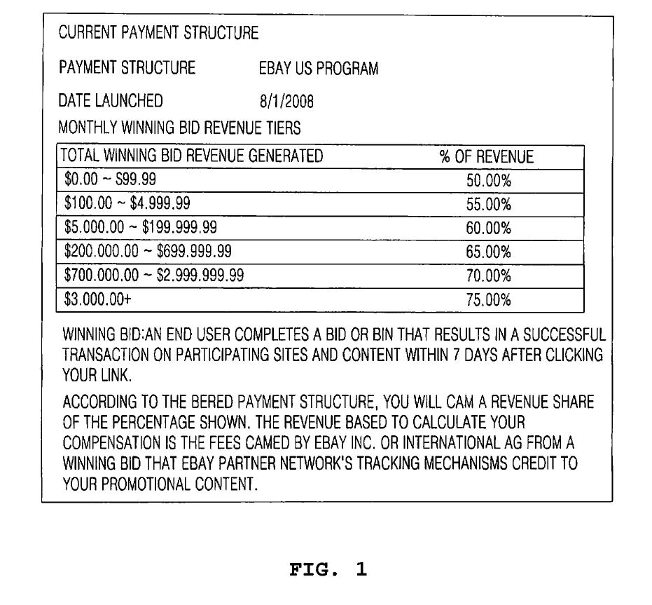

FIG. 2 is a revenue information page for Google's AdSense affiliate advertising;

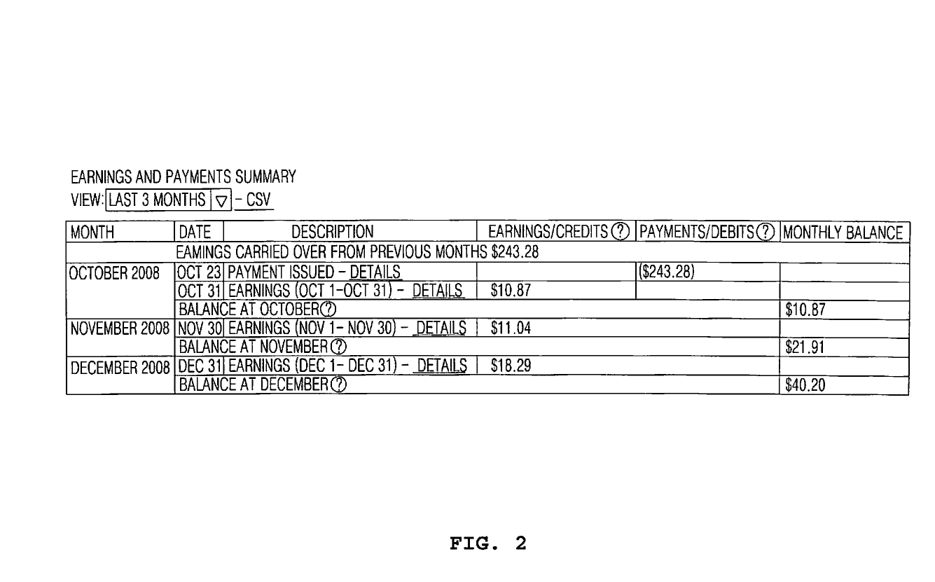

FIG. 3 is a diagram showing the overall construction of an Internet search engine affiliate system according to the preferred embodiment of the present disclosure;

FIG. 4 is a diagram showing an example of a search target selection screen for the linking of products;

FIG. 5 is a diagram showing an example of a search result screen for the linking of products;

FIG. 6 is a diagram showing an example of a displayed link image and additional information screen;

FIG. 7A is a diagram showing an example of a category-based selection screen for the exposure of linked products;

FIG. 7B is a diagram showing an example of a screen in which linked products are exposed at specific locations of a category-based page;

FIG. 7C is a diagram showing a keyword-based selection screen for the exposure of linked products;

FIG. 7D is a diagram showing an example of a screen in which linked products are exposed at specific locations of a keyword-based page;

FIG. 8 is a diagram showing an example of an information input screen for the assignment of affiliate link URL codes; and

FIG. 9 is a flowchart showing the overall construction of an Internet search engine affiliate method according to an embodiment of the present disclosure.

### DETAILED DESCRIPTION

Reference now should be made to the drawings, in which the same reference numerals are used throughout the different drawings to designate the same or similar components.

Prior to providing a detailed description for the practice of the present disclosure, it is noted that detailed descriptions of constructions that are not directly related to the technical gist of the present disclosure are omitted within a range that does not make the technical gist of the present disclosure obscure.

Furthermore, the terms and words used in the present specification and the accompanying claims should be interpreted as having meanings suitable for the technical spirit of the present disclosure on the basis of the principle that an inventor can appropriately define the concepts of terms in order to describe his or her disclosure in the best way.

The definitions of the terms used in the present specification will be given below.

A ‘merchant site’ includes a product sales website, such as EBay, or an information sales website that provides paid information or paid advertisements, such as Google.

‘Merchandise’ includes products sold by a product sales website and paid information or advertisements provided by an information sales website.

A ‘merchandise buyer’ refers to a person who buys or searches for a product at a product sales website or buys or searches for information or an advertisement on an information sales website.

A ‘merchandise seller’ refers to a person who sells a product at a product sales website or an advertiser of an information sales website.

An ‘affiliate’ refers to a person who plays a specific role including affiliate advertising for a merchant site and receives a predetermined commission from the merchant site.

In the present disclosure, all of an affiliate application provider server 200, an application distributor terminal 300, an application affiliate terminal 400 and a seller terminal 600 may function as affiliates.

An ‘affiliate’ refers to a person who is supplied with an application by the affiliate application provider server 200, advertises the application and creates revenue based on affiliate advertising.

In the present disclosure, both the application distributor terminal 300 and the application affiliate terminal 400 may function as affiliates.

In the present specification, if not particularly described, an ‘affiliate’ may refer to one or more of the affiliate application provider server 200, the application distributor terminal 300, the application affiliate terminal 400 and the seller terminal 600 as occasion demands.

An Internet search engine affiliate system according to a preferred embodiment of the present disclosure will be described below with reference to the accompanying drawings.

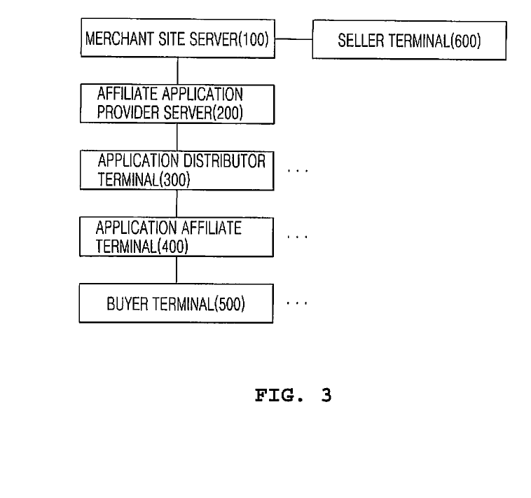

FIG. 3 is a diagram showing the overall construction of the Internet search engine affiliate system according to the preferred embodiment of the present disclosure.

As shown in FIG. 3, the Internet search engine affiliate system according to the preferred embodiment of the present disclosure includes the merchant site server 100, the affiliate application provider server 200, the application distributor terminal 300, the application affiliate terminal 400, a buyer terminal 500, the seller terminal 600 and the Internet.

First, the merchant site server 100 is the server of a merchant site such as a product sales website that provides a space for the selling or buying of products over the Internet or an information sales website that provides paid information or paid advertisements over the Internet. The merchant site server 100 grants a right to access an Application Programming Interface (API) database, including the merchandise information of the merchant site, to the affiliate application provider server 200 or an affiliate (the application distributor terminal 300 or the application affiliate terminal 400), thereby allowing the affiliate application provider server 200 or the affiliate to perform affiliate advertising for merchandise registered on the merchant site.

The merchant site may be a product sales website that provides a space for the selling or buying of products over the Internet or an information sales website that provides paid information or paid advertisements over the Internet, as well as EBay and Google.

The merchandise is not limited to specific items, but may be paid information or paid advertisements, as well as products such as clothes, items for interior decoration, houses or cars.

Furthermore, the affiliate application provider server 200 makes an affiliate advertising contact with the merchant site server 100 for merchandise on the basis of standard provisions or some other mutual agreement, and supplies an application according to a preferred embodiment of the present disclosure to the application distributor terminal 300 or the application affiliate terminal 400.

The application distributor terminal 300, the application affiliate terminal 400 and the buyer terminal 500 may be selectively connected to the affiliate application provider server 200 as subordinate elements. The application affiliate terminal 400 and the buyer terminal 500 may be selectively connected to the application distributor terminal 300 as subordinate elements. The buyer terminal 500 may be connected to the application affiliate terminal 400 as a subordinate element.

An application according to the present disclosure of a preferred embodiment will be described in detail below.

The application is software for performing an affiliate merchandise advertising function over the Internet. The application is supplied by the affiliate application provider server 200, is then managed by the application distributor terminal 300 or the application affiliate terminal 400 or installed in a specific space of a website having high efficacy, and displays the information about the merchandise of the merchant site on the buyer terminal 500.

The application may be produced by the affiliate application provider server 200, or may be produced by the merchant site server 100 and then supplied to the affiliate application provider server 200, the application distributor terminal 300 or the application affiliate terminal 400.

On the basis of the supply of the application by the affiliate application provider server 200, the application distributor terminal 300 or the application affiliate terminal 400 functions as an affiliate. It is apparent that the affiliate application provider server 200 or the seller terminal 600 also functions as an affiliate. In the present specification, an “affiliate” refers to one or more of the affiliate application provider server 200, the application distributor terminal 300, the application affiliate terminal 400 and the seller terminal 600.

The application includes a function of linking only merchandise that has been registered on the merchant site and is desired by the affiliate to an affiliate's own website (including an online community, a blog, etc.).

On the basis of having linked the merchandise, the affiliate can advertise the merchandise on his or her website. When the merchandise advertised by the affiliate is bought by a merchandise buyer, the affiliate receives part of the sales revenue from the merchant site server 100 in reward for the affiliate advertising. It is apparent that the affiliate may additionally link the merchandise of an online shopping mall managed directly by himself or herself on his or her website or the merchandise of the website of a third party to the application and sell the merchandise.

This linking of merchandise will be described in detail below.

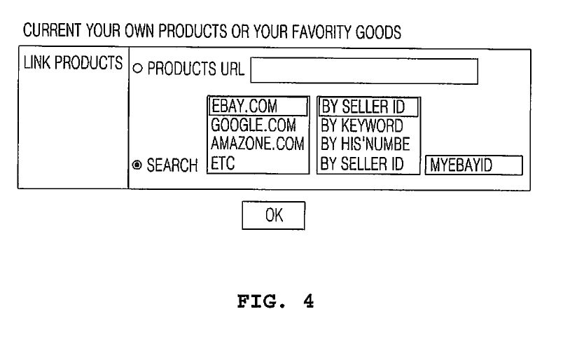

The application supports a function of searching for merchandise registered on the merchant site so as to facilitate the linking of the merchandise. After executing the supplied application, the affiliate selects a search target merchant site from among merchant sites, such as EBay, Amazon and Google, in a search screen provided by the application (for example, a screen shown in FIG. 4) and then searches for registered merchandise by inputting a merchandise seller's ID or by using keyword or category classification. It is apparent that by using the application, the affiliate may search for merchandise registered on a specific website desired by the affiliate, in addition to the merchandise of the merchant site served by the affiliate application provider server 200.

When the affiliate requests searching for merchandise through the search screen provided by the application so as to link the merchandise, it is preferred that the affiliate application provider server 200 directly search through merchandise registered on the merchant site and provide search results to the affiliate. Alternatively, the affiliate application provider server 200 may transfer a merchandise search request signal to the merchant site server 100, and the merchant site server 100 may search through registered merchandise and provide search results.

In the case where the affiliate himself or herself links the merchandise of a website for which the affiliate application provider server 200 does not support the linking of the merchandise as described above, the affiliate application provider server 200 requests and collects commission in reward for the linking of the merchandise. Furthermore, the affiliate application provider server 200 sets up its own merchandise linking database, and, in the case where a merchandise buyer searches through merchandise using the buyer terminal 500, accesses an API database including the merchandise information of the merchant site in real time and displays existing merchandise. In this case, previously linked merchandise is displayed first.

In the case where the affiliate links merchandise, the affiliate application provider server 200 displays merchandise information retrieved by the affiliate, together with additional information, on the affiliate terminal, and the affiliate terminal sends a merchandise link request signal to the affiliate application provider server 200.

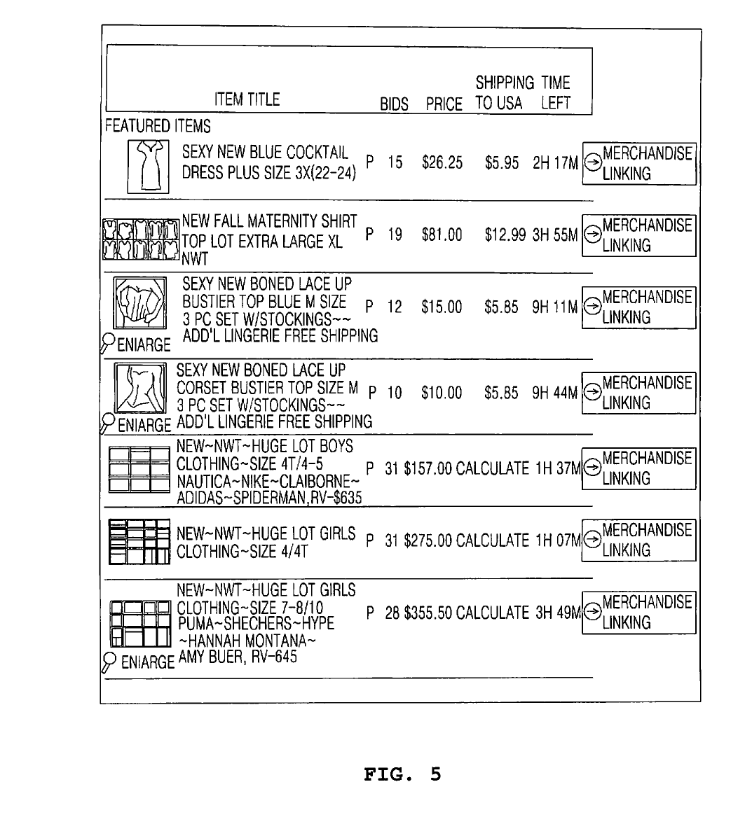

In FIG. 5, an example in which retrieved merchandise information is displayed is shown. When the affiliate clicks a merchandise linking button shown on the right side of FIG. 5, the affiliate terminal sends a merchandise link request signal to the affiliate application provider server 200.

The affiliate application provider server 200 creates a link image that embodies the features of merchandise for which the merchandise link request signal was received. It is preferred that a link image include one or more of the appearance information (outline), auxiliary information, feature demarcation line, texture, pattern, color and brand information of each piece of merchandise. In the case where the merchandise is clothes, a link image may include the silhouette (outline), pattern and color information of a clothes image.

When a link image is created, the affiliate application provider server 200 receives information related to merchandise selected by the affiliate (in the case where the merchandise is clothes, a category, a silhouette, a pattern, a color, a material, a style, a size, gender, an age and a clothes image) from the merchant site server 100, so that the affiliate can easily create a link image without additionally selecting merchandise-related information.

For example, in the case where a merchandise seller registers a clothes product on EBay, options, such as category1, category2, occasion, style, sleeve style, brand, color and material, may be selected. After the affiliate application provider server 200 has received such information from EBay, the affiliate application provider server 200 may use the received information for the creation of a link image.

The image simulation method disclosed in Korean Patent No. 10-0849420 entitled “Image-based Search System and Method” may be used for the creation of a link image.

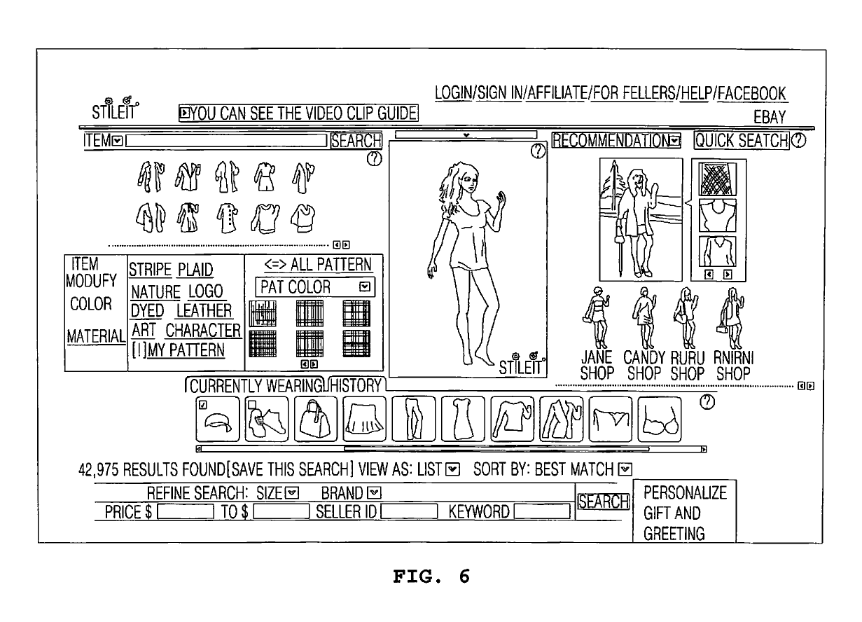

The affiliate application provider server 200 displays the created link image on the affiliate terminal. When the affiliate changes the additional information of the displayed link image such as an outline, a feature demarcation line, a texture, a pattern, a color or brand information, a complete image obtained by amending or improving the link image is created. For example, the affiliate may create a complete image by viewing a link image displayed on the left upper portion of FIG. 6 and selecting additional information, such as a texture, a pattern or a color, displayed on the left center portion of FIG. 6.

Here, the affiliate application provider server 200 may display recommended similar images, together with the created link image, on the affiliate terminal through the application.

In the case where the appearance information of merchandise desired by the affiliate does not exist on the affiliate application provider server 200, the affiliate application provider server 200 provides the previously prepared additional information of various pieces of merchandise, such as appearance information (outline), auxiliary information, feature demarcation lines, textures, patterns, colors or brand information, to the affiliate terminal through the application. The affiliate may create a desired complete image by embodying an image or directly constructing an image using the provided additional information. The affiliate may store the link image or complete image in the affiliate terminal.

The affiliate application provider server 200 stores the complete image for the linking of merchandise and complete image-related information. The affiliate application provider server 200 links the complete image to the merchandise of the merchant site using the complete image-related information.

The affiliate application provider server 200 may send the stored complete image or complete image-related information to the affiliate terminal, and the affiliate may reuse or amend the complete image for the future linking of similar merchandise.

Detailed complete image-related information includes a linker's (affiliate) mail address (for the identification of the linker), the appearance information (outline), auxiliary information, feature demarcation line, texture, pattern, color and brand information of merchandise, the merchandise URL information of a merchant site, and information about a link image created through the application.

The number of times the affiliate registers a complete image for the linking of merchandise on the affiliate application provider server 200 may be limited, and registration fees may be charged. In the case where the affiliate registers completes image for the linking of merchandise a number of times equal to or larger than a predetermined number, additional fees may be charged. The manager of the affiliate application provider server 200 may examine registered complete images for the linking of merchandise and determine the exposure of the merchandise.

When a merchandise buyer searches for a desired piece of merchandise using a complete image, it is preferable to exposure target merchandise in the following sequence if the target merchandise exists in the merchant site.

1. Merchandise exposed on application executed by affiliate himself or herself for his or her own merchandise

2. Merchandise linked by third party merchandise seller for a payment

3. Merchandise linked by third party merchandise seller free of charge

4. Merchandise retrieved through keyword searching

5. Merchandise retrieved through image searching

In the case where merchandise is linked for a payment, the registration or exposure of merchandise may be charged at a predetermined fee or on a Cost Per Click (CPC) basis. The exposure or advertising of linked merchandise at a specific location of a website provided by the application may be charged for.

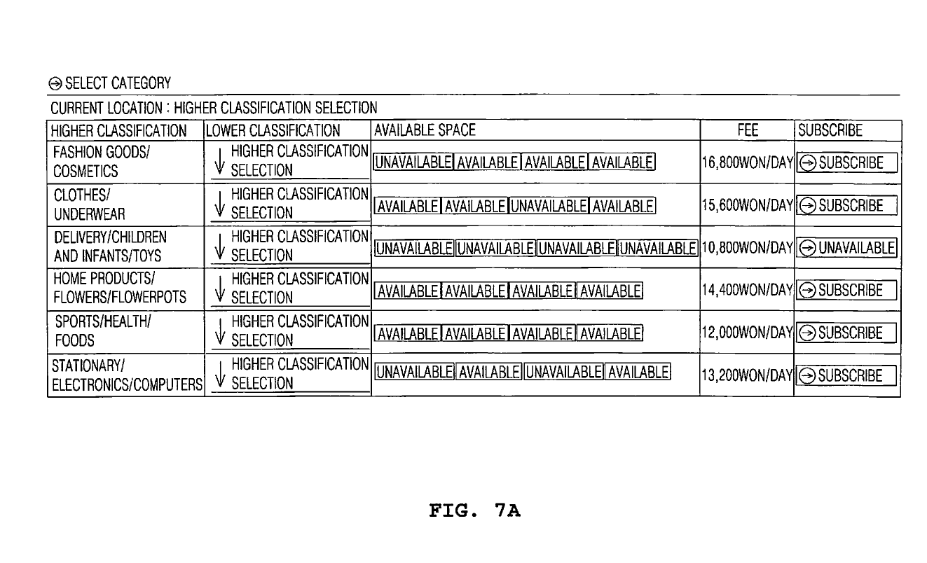

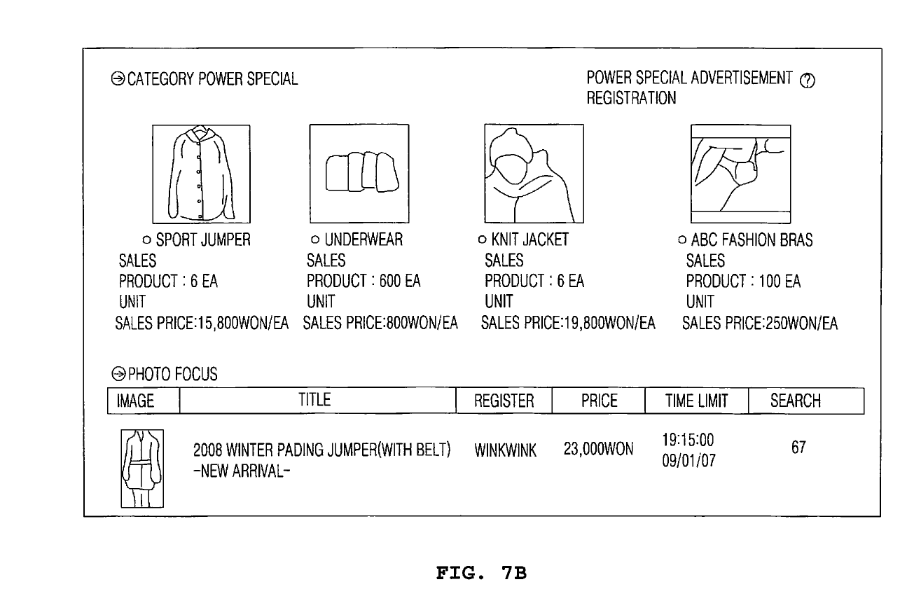

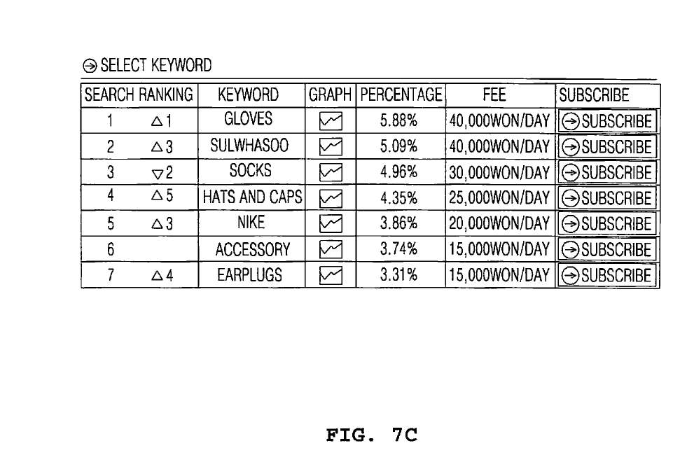

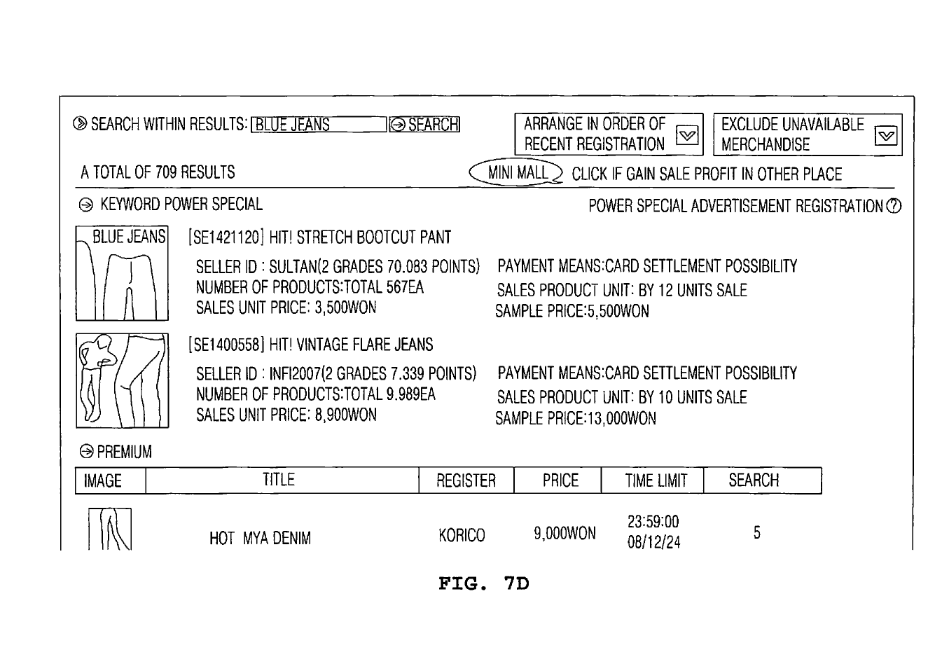

As shown in FIG. 7A, the affiliate may select category-based classification, and expose or advertise the linked merchandise at a specific location of a selected category page. As a result, as shown in FIG. 7B, the linked merchandise is exposed or advertised at the specific location of the category page.

Furthermore, as shown in FIG. 7C, the affiliate may select keyword-based classification and expose or advertise linked merchandise at a specific location of a selected keyword page. As a result, as shown in FIG. 7D, the linked merchandise is exposed or advertised at the specific location of the keyword page.

An application created and executed by the affiliate himself or herself provides a list page capable of displaying the complete image, link image or recommended similar image of the linked merchandise to merchandise buyers. The affiliate may modify, delete or add the complete image, link image or recommended similar image of the linked merchandise in the list page.

In the case where a merchandise buyer selects an image with a specific appearance so as to search for merchandise through the application, it is preferable to display only the material, pattern or color of the merchandise with the same appearance which has been linked to the merchant site server 100. However, it is preferable to display all appearance information (outline), auxiliary information, feature demarcation lines, textures, patterns and colors, constructed or prepared by the affiliate application provider server 200, on the screen of the seller terminal 600 that manages the linking of merchandise as a merchandise seller, thereby enabling the linking of merchandise actually being sold to appearance information (an outline, auxiliary information, a feature demarcation line, a texture, a pattern and/or a color).

When a merchandise buyer clicks, for example, a “similar merchandise search” button on the web page of a merchant site for which the linking of the merchandise has been completed, the complete image and similar image of the linked merchandise are displayed through the image simulation of the application and the complete image and then the similar merchandise are retrieved and displayed. The merchandise buyer may search for new merchandise by changing one or more of the appearance information (outline), auxiliary information, feature demarcation line, texture, pattern, color and brand information of the complete image or similar image through the image simulation.

When the merchandise seller registers the pattern of merchandise, the pattern is classified. If the merchandise seller registers the actual pattern of merchandise being sold by him or her, this will help the accurate linking of the merchandise.

In detail, patterns are classified according to the configuration, representative colors, and inclusion of characters or famous logos of the patterns. For this purpose, it is preferable to analyze representative patterns or colors on the basis of the analysis of target merchandise, that is, the extraction of the feature points of outline. For example, the affiliate application provider server 200 stores previously prepared standard pattern data, and classifies a pattern registered by a merchandise seller as the most similar standard pattern by comparing the feature points of the registered pattern with the standard pattern data.

When the merchandise seller registers the material of merchandise, the material is classified. For the classification of material, a method similar to the above-described pattern classification method may be used.

For the merchandise buyer to use his or her unique space provided by the application, for example, a closet, it is preferable to open an account. The merchandise buyer may store merchandise information and a merchandise searching single image or combined image in which single images are combined together, in his or her unique space.

When the merchandise seller registers merchandise identical or similar to that of the merchandise information or merchandise search image previously registered by the merchandise buyer in his or her unique space, the affiliate application provider server 200 sends a notice message to the merchandise buyer. The affiliate application provider server 200 may send the notice message through the buyer's mobile phone, mail, web browser, toolbar or Windows application. Furthermore, the affiliate application provider server 200 may send a text message to the buyer's mobile phone, through which the merchandise buyer can receive a notice message without accessing the application.

The application supports a function of uploading the merchandise buyer's own background screen and a function of inputting his or her own face and selecting his own skin color or body type.

The affiliate application provider server 200 may set up a separate online shopping mall by displaying the overall merchandise linked to the application on a webpage. The affiliate application provider server 200 may adopt an affiliate program, and request affiliate advertising from affiliates, like EBay. In detail, a subscribing affiliate may be subject to the initiation of effective affiliate advertising activities within 50 days, or may be subject to a merchandise buyer's buying merchandise within 7 days thanks to affiliate advertising.

Merchandise may be searched for using a keyword, a category, an event or a banner as a search condition. The accuracy of searching can be improved through image-based searching. On the basis of image-based searching, when a merchandise seller links a clothes product, searching may be performed using a style or a pattern as a search condition, in addition to a category, a keyword and a brand. In detail, the method disclosed in Korean Patent No. 10-0849420 entitled “image-based searching system and method” may be used as an image-based searching method.

According to the present disclosure, a merchandise buyer can construct an image that embodies search target merchandise by selecting a category or detailed images of a neck, a sleeve or the like without requiring image simulation. According to the present disclosure, it is possible to display search results based on linking with a merchandise seller without requiring an image analysis program. Furthermore, options may be checked through image simulation.

From the standpoint of the merchant site server 100, according to the present disclosure, a merchandise seller attempts to maximally expose merchandise being sold by him or her on the application, so that the merchandise seller attempts to accurately set a category. Furthermore, in the case where a merchandise seller links merchandise using a paid option so as to expose his or her merchandise at an upper position of the application, additional revenue can be created. Furthermore, the present disclosure can improve the amount of sales by stimulating merchandise buyers' interests in searching for merchandise based on image linking (image simulation provided by the application). Moreover, a custom-tailored clothing article may be provided to a merchandise buyer through image simulation provided by the application.

Furthermore, the application distributor terminal 300 is an application supplier's computer or space on the Internet. The application distributor terminal 300 receives an application from the affiliate application provider server 200, and supplies the application to the application affiliate terminal 400.

The application distributor terminal 300, the application affiliate terminal 400, the buyer terminal 500 or the seller terminal 600 supports a function of installing and executing the application. It is provided with an Internet browser, for example, Netscape or Internet Explorer, which is capable of displaying web content in Hyper Text Markup Language (HTML) format. It may be set to a personal computer, a Personal Digital Assistant (PDA) or a mobile phone which is capable of displaying web pages.

The affiliate acting as an application supplier merchant site accesses EBay, Amazon or Google, and is then assigned an affiliate ID for the accessed merchant site so as to receive revenue in reward for affiliate advertising. That is, the affiliate subscribes to an affiliate program provided by a merchant site, and acquires an affiliate ID of the merchant site. A merchant site, such as EBay, Amazon or Google, provides a link URL code including a specific person's affiliate ID.

It is envisioned that the application distributor terminal 300 or the application affiliate terminal 400 is assigned a link URL code capable of installing an application in a specific space of a website by the application supplied by the affiliate application provider server 200. The link URL code includes affiliate identification information that is used to identify an installer.

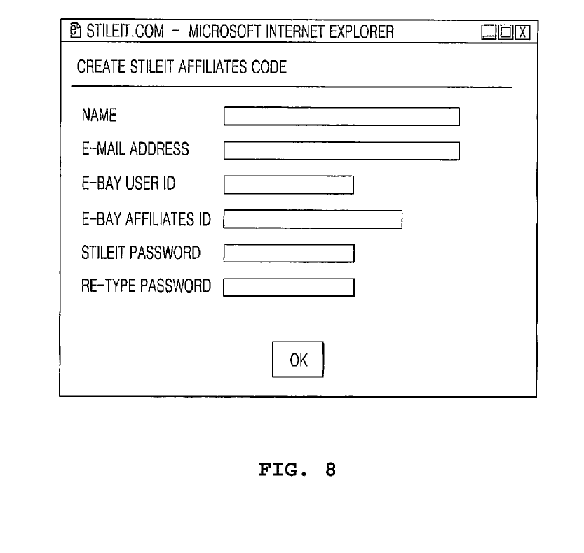

For example, in the case of EBay, information necessary when the affiliate application provider server 200 assigns a link URL code for running the application to the application distributor terminal 300 or the application affiliate terminal 400 will be described below. FIG. 8 shows an example of an information input screen that is used when the application distributor terminal 300 or the application affiliate terminal 400 is assigned an application link URL code by the affiliate application provider server 200.

1. EBay ID

2. EBay affiliate ID

3. e-mail address

4. name/password

5. affiliate logo image

An EBay ID is an ID which is used when a seller or a buyer sells or buys merchandise on EBay, and is required when an affiliate links the affiliate's own merchandise to the application. The affiliate may perform selection so that the application created by him or her displays only his or her own merchandise or merchandise for affiliate advertising to the public.

The EBay affiliate ID is used to receive commission in reward for affiliate advertising from the merchant site, and the e-mail address is used for the affiliate application provider server 200 to identify each affiliate.

Furthermore, the name/password is used when an affiliate amends various types of information. The affiliate logo image is inserted into the application (for example, at the left upper end of the application) and is then displayed, so that the affiliate advertises the application as his or her own application and merchandise buyers can easily identify the affiliate of the application.

When each affiliate executes such a link URL code using an Internet browser, the affiliate's own application is run. In order to run an application, the method of a link URL (http://˜), a popup window <popup window˜>, a layer <layer˜> or iframe <iframe˜> is used.

When a merchandise buyer visits the application and buys merchandise, the beneficiary of commission in reward for affiliate advertising is determined depending upon which affiliate ID, that is, which affiliate ID of a merchant site, was assigned to the merchandise.

The preferred distribution rates of commission in reward for affiliate advertising will be described below.

If the Internet search engine affiliate system according to a preferred embodiment of the present disclosure is configured to have three levels (the levels of the affiliate application provider server 200, the application distributor terminal 300 and the application affiliate terminal 400), link URL codes including respective affiliate IDs of the merchant site are assigned at rates of 25%, 25% and 50% of the total number of times a merchandise buyer has attempted merchandise searching on the application.

For example, when the merchandise buyer performs merchandise searching on the application, a randomly selected first affiliate ID is assigned to a search result list based on a first merchandise search request. When the merchandise buyer performs second merchandise searching on the application, a second affiliate ID is assigned. Accordingly, if the merchandise buyer buys merchandise during first merchandise searching, the beneficiary of affiliate advertising commission is the holder of the first affiliate ID. If the second affiliate ID is assigned on the basis of second merchandise searching and the merchandise buyer visits the corresponding merchant site last, the holder of the second affiliate ID is the beneficiary of affiliate advertising commission (for example, within 7 days after the last visit). However, if 2 days after the second affiliate ID has been assigned and the merchandise buyer has visited the merchant site, the merchandise buyer performs new merchandise searching on the application, is assigned a third affiliate ID and then visits the corresponding merchant site, the second affiliate ID is deleted and the holder of the third affiliate ID is the beneficiary of affiliate advertising commission (for example, within 7 days after the last visit).

If the Internet search engine affiliate system according to a preferred embodiment of the present disclosure is configured to have 2 levels (for example, the levels of the affiliate application provider server 200 and the application affiliate terminal 400), link URL codes including respective affiliate IDs of the merchant site are assigned at ratios of 50% to 50%, or 25% to 75% with respect to the total number of times.

In greater detail, in the case where the merchant site is EBay, when the merchandise buyer buys merchandise through the application, the merchant site server 100 pays the affiliate application provider server 200 or the affiliate (the application distributor terminal 300 or the application affiliate terminal 400) 50%˜75% of the sales commission which is paid by the merchandise seller.

An affiliate link URL code is assigned to the affiliate application provider server 200 at a rate in the range of 25%˜100%. 25% affiliate link URL codes are applied to the case where the merchandise buyer buys merchandise through the application affiliate terminal 400 connected to the application distributor terminal 300, 25% affiliate link URL codes are applied to the case where the merchandise buyer buys merchandise through the application affiliate terminal 400 directly connected to the affiliate application provider server 200, and 100% affiliate link URL codes are applied to the case where the merchandise buyer buys merchandise directly through the affiliate application provider server 200.

For the application distributor terminal 300, 25% affiliate link URL codes are applied to the case where the merchandise buyer buys merchandise through the application affiliate terminal 400, and 75% affiliate link URL codes are applied to the case where the merchandise buyer buys merchandise directly through the application distributor terminal 300.

For the application affiliate terminal 400, 50% affiliate link URL codes are applied to the case where the application affiliate terminal 400 is connected to the application distributor terminal 300, and 75% affiliate link URL codes are applied to the case where the application affiliate terminal 400 is connected to the affiliate application provider server 200.

Both of the application distributor terminal 300 and the application affiliate terminal 400 receive affiliate advertising commission directly from the merchant site. Accordingly, the affiliate application provider server 200 does not need to set up a separate system (hardware or software) for settling merchandise sales commission, and does not need to make additional efforts related to the settlement of merchandise sales commission. All affiliates that perform affiliate advertising using the application distributor terminal 300 and the application affiliate terminal 400 can trust a merchant site (for example, EBay or Google), and can perform stable affiliate advertising work.

The application distributor terminal 300 may perform the function of the buyer terminal 500 which will be described later, and has the merchandise recommendation function disclosed in Korean Patent No. 10-0687906 entitled “Merchandise recommendation system and method.”

Furthermore, the application affiliate terminal 400 advertises the application to the buyer terminal 500, and receives affiliate advertising commission (sales commission).

Furthermore, the buyer terminal 500 is the computer of a merchandise buyer. The buyer terminal 500 comes into contact with an advertisement provided by the affiliate application provider server 200, the application distributor terminal 300 or the application affiliate terminal 400 and buys the merchandise of the advertisement. The buyer terminal 500 may also have the merchandise recommendation function disclosed in Korean Patent No. 10-0687906 entitled “Merchandise recommendation system and method.”

Furthermore, the seller terminal 600 is the computer of a merchandise seller. The merchandise seller registers merchandise to be sold on a merchant site provided by the merchant site server 100, and pays the merchant site server 100 a predetermined sales commission if the merchandise is sold.

The merchandise seller may also be an affiliate. The merchandise seller increases the amount of sales of merchandise being sold using the application, and may receive part of the sales commission revenue when some other person's merchandise is sold.

Meanwhile, the Internet functions to connect the merchant site server 100, the affiliate application provider server 200, the application distributor terminal 300, the application affiliate terminal 400, the buyer terminal 500 and/or the seller terminal 600 to each other.

The Internet includes the wired Internet based on the TCP/IP protocol and the wireless Internet based on the WAP protocol.

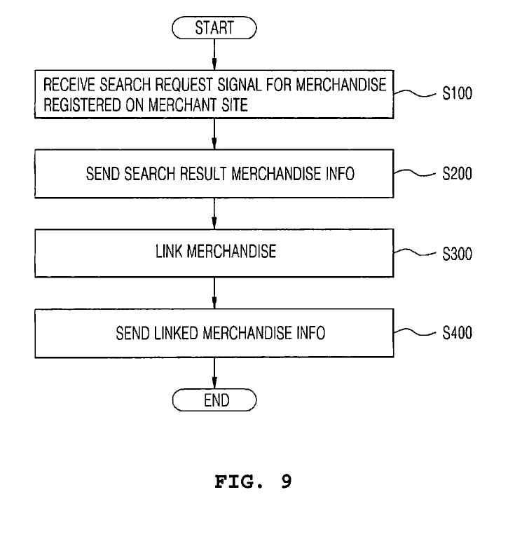

An Internet search engine affiliate method using the Internet search engine affiliate system according to a preferred embodiment of the present disclosure will be described with reference to FIG. 9.

FIG. 9 is a flowchart showing the overall construction of the Internet search engine affiliate method according to an embodiment of the present disclosure.

As shown in FIG. 9, the affiliate application provider server 200 receives a search request signal for merchandise registered on the merchant site from the application distributor terminal 300 through the application at step S100.

Thereafter, the affiliate application provider server 200 sends merchandise information based on search results obtained as a result of searching through the application to the application distributor terminal 300 at step S200.

Thereafter, the affiliate application provider server 200 receives a merchandise link request signal for a specific piece of merchandise from the application distributor terminal 300 and links the merchandise for which the merchandise link request signal has been received to corresponding merchandise registered on the merchant site at step S300.

Step S300 will be described below.

The affiliate application provider server 200 receives the related information of merchandise for which the merchandise link request signal has been received from the merchant site server 100, creates a link image that embodies the features of the merchandise, and sends the created link image to the application distributor terminal 300.

Here, the affiliate application provider server 200 may send a similar recommended image, together with the created link image, to the application distributor terminal 300. The application distributor terminal 300 creates a link image using the received link image creation information, and sends the created link image to the affiliate application provider server 200.

When a change request signal for the sent link image is received from the application distributor terminal 300, the affiliate application provider server 200 creates a complete image obtained by changing the link image, and sends the complete image to the application distributor terminal 300.

Furthermore, if image information that embodies merchandise for which the merchandise link request signal has been received does not exist in the affiliate application provider server 200, the affiliate application provider server 200 may send link image creation information previously prepared for the merchandise for which the merchandise link request signal has been received to the application distributor terminal 300.

That is, if the appearance information of merchandise desired for linking by the affiliate does not exist in the affiliate application provider server 200, the affiliate application provider server 200 sends the previously prepared additional information of various pieces of merchandise, such as the appearance information (outline), auxiliary information, feature demarcation lines, textures, patterns, colors and brand information of the merchandise, to the affiliate terminal through the application. The affiliate may create a desired link image by directly constructing or embodying the image using the received additional information.

Finally, when a search request signal for merchandise desired by a buyer is received from the buyer terminal 500, the affiliate application provider server 200 first sends information about linked merchandise to the buyer terminal 500 at step S400.

According to the present disclosure, there is an advantage in that an affiliate application provider supplies a specific application program to affiliates and the affiliates advertise the application program to merchandise buyers, so that a merchant site, the affiliate application provider and the affiliates, which are related to the system, can create fair revenue.

According to the present disclosure, there is another advantage in that an affiliate application provider receives advertising commission from a merchandise seller who requests a paid advertisement from the application program, thereby creating additional revenue.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. An Internet search engine affiliate system, comprising:
a merchant site server, the merchant site server being a server of a merchant site including a product sales website for providing an online space for sales or buying of one or more products over an Internet and an information sales website for providing paid information or at least one paid advertisement, the merchant site server being provided with a database storing merchandise information of the merchant site;
at least one affiliate application provider server for distributing at least one application, that is, software for performing an affiliate advertising function for merchandise, to at least one application distributor terminal over the Internet, and, when the application distributor terminal receives a search request signal for merchandise registered on the merchant site from at least one buyer terminal through the application, sending search result merchandise information in response to the search request signal to the buyer terminal through the application;
the application distributor terminal for executing the distributed application, sending information about the merchandise registered on the merchant site to the buyer terminal over the Internet, and receiving the search request signal for the merchandise registered on the merchant site from the buyer terminal through the application;
the buyer terminal for receiving and displaying the information about the merchandise registered on the merchant site; and
the Internet for connecting the merchant site server, the affiliate application provider server and the application distributor terminal to each other.

2. The Internet search engine affiliate system as set forth in claim 1, further comprising at least one seller terminal for sending a merchandise registration request signal including merchandise information to be sold on the merchant site to the merchant site server.

3. The Internet search engine affiliate system as set forth in claim 1, wherein the affiliate application provider server has a function of receiving a merchandise link request signal for merchandise for affiliate advertising from the application distributor terminal and linking the merchandise for which the merchandise link request signal has been received to corresponding merchandise registered on the merchant site.

4. The Internet search engine affiliate system as set forth in claim 3, wherein the affiliate application provider server has a function of receiving related information of the merchandise for which the merchandise link request signal has been received from the merchant site server, creating a link image that embodies features of the merchandise using the received related information, and sending the created link image to the application distributor terminal.

5. The Internet search engine affiliate system as set forth in claim 4, wherein the affiliate application provider server has a function of, when a signal requesting a change of the link image is received from the application distributor terminal, creating a complete image obtained by changing the link image and sending the complete image to the application distributor terminal.

6. The Internet search engine affiliate system as set forth in claim 4, wherein the affiliate application provider server has a function of sending at least one recommended image similar to the created link image to the application distributor terminal.

7. The Internet search engine affiliate system as set forth in claim 4, wherein:
the affiliate application provider server has a function of, when appearance information of the merchandise for which the merchandise link request signal has been received does not exist in the affiliate application provider server, sending previously prepared link image creation information for the merchandise for which the merchandise link request signal has been received to the application distributor terminal; and
the application distributor terminal has a function of creating a link image using the received link image creation information and sending the created link image to the affiliate application provider server.

8. The Internet search engine affiliate system as set forth in claim 4, wherein the related information comprises one or more of appearance information (an outline), auxiliary information, a feature demarcation line, a texture, a pattern, color and brand information of the merchandise.

9. The Internet search engine affiliate system as set forth in claim 3, wherein the application distributor terminal has a function of linking the merchandise for affiliate advertising to corresponding merchandise registered on a website, other than the merchant site, and the application.

10. The Internet search engine affiliate system as set forth in claim 9, wherein the affiliate application provider server has a function of, when the application distributor terminal performs linking to the merchandise registered on the website, other than the merchant site, sending a payment request signal to the application distributor terminal.

11. The Internet search engine affiliate system as set forth in claim 1, wherein the application distributor terminal has a function of causing the application, run by the application distributor terminal, to display only information about merchandise for which the application distributor terminal performs affiliate sales or advertising on the buyer terminal.

12. The Internet search engine affiliate system as set forth in claim 1, wherein the affiliate application provider server has a function of storing standard pattern data for merchandise and classifying feature points of the merchandise for which the merchant site server has received a merchandise registration request signal as a standard pattern by comparing feature points of a pattern of the merchandise with the standard pattern data.

13. The Internet search engine affiliate system as set forth in claim 2, wherein:
the buyer terminal has a function of storing merchandise information or merchandise searching image information; and
the affiliate application provider server has a function, when the seller terminal sends a merchandise registration request signal for merchandise identical or similar to that of the merchandise information or merchandise searching image information stored by the buyer terminal, sending a notice message to the buyer terminal and a text message to the buyer's mobile phone.

14. The Internet search engine affiliate system as set forth in claim 3, wherein the affiliate application provider server has a function of sending and displaying information about the linked merchandise to and on the buyer terminal in webpage form, and, when a signal requesting exposure of the merchandise information at a specific location of the webpage is received from the application distributor terminal, exposing the merchandise information at the specific location of the webpage.

15. The Internet search engine affiliate system as set forth in claim 5, wherein the merchant site server or affiliate application provider server has a function of sending and displaying information about the linked merchandise to and on the buyer terminal in webpage form, and, when a similar merchandise search request signal for the linked merchandise is received from the buyer terminal, sending and displaying a complete image and its similar image used for the linking of the merchandise to and on the buyer terminal.

16. The Internet search engine affiliate system as set forth in claim 15, wherein the merchant site server or the affiliate application provider server has a function of, when it receives a similar merchandise search request signal using the displayed complete image or its similar image as a search condition from the buyer terminal, sending and displaying merchandise information of the displayed complete image or its similar image to and on the buyer terminal.

17. The Internet search engine affiliate system as set forth in claim 16, wherein the merchant site server or the affiliate application provider server has a function of changing one or more of appearance information (an outline), auxiliary information, a feature demarcation line, a texture, a pattern, a color and brand information of the displayed complete image or its similar image in order to search for new merchandise information by changing the displayed complete image or its similar image.

18. The Internet search engine affiliate system as set forth in claim 1, wherein the merchant site server has a function of, when the buyer terminal sends a buying request signal for merchandise to the merchant site server through the application, sending a sales commission deposit signal to the affiliate application provider server or a specific application distributor terminal.

19. The Internet search engine affiliate system as set forth in claim 1, wherein the merchant site server has a function of, when the buyer terminal sends a buying request signal for merchandise to the merchant site server through the application, determining whether to send a sales commission deposit signal to the affiliate application provider server or a specific application distributor terminal depending on which affiliate ID of the merchant site has been assigned to the merchandise for which buying has been requested.

20. The Internet search engine affiliate system as set forth in claim 1, wherein the merchant site server has a function of, when the buyer terminal sends a buying request signal for merchandise to the merchant site server through the application, determining whether to send a sales commission deposit signal to the affiliate application provider server or a specific application distributor terminal, and identifying the affiliate application provider server or application distributor terminal to which the merchant site server will send the sales commission deposit signal using a code on an affiliate program assigned to the merchandise by the affiliate application provider server.

21. The Internet search engine affiliate system as set forth in claim 19, wherein the merchant site server has a function of randomly assigning affiliate IDs of the merchant site to the merchandise the buying of which has been requested at predetermined percentages of the number of times the buyer terminal has attempted merchandise searching using the application.

22. An Internet search engine affiliate method using an Internet search engine affiliate system including a merchant site server, the merchant site server being a server of a merchant site including a product sales website for providing an online space for sales or buying of one or more products over an Internet and an information sales website for providing paid information or at least one paid advertisement, at least one affiliate application provider server for distributing at least one application, that is, software for performing an affiliate advertising function for merchandise, to at least one application distributor terminal over the Internet, the application distributor terminal for executing the distributed application and sending information about the merchandise registered on the merchant site to the buyer terminal over the Internet, the buyer terminal for displaying the received merchandise information, at least one seller terminal for sending a merchandise registration request signal including information about merchandise to be sold on the merchant site to the merchant site, and the Internet for connecting the merchant site server, the affiliate application provider server, the application distributor terminal and the seller terminal to each other, the method comprising the steps of:
(a) the affiliate application provider server receiving a search request signal for merchandise registered on the merchant site from the application distributor terminal through the application;
(b) the affiliate application provider server sending search result merchandise information to the application distributor terminal through the application;
(c) the affiliate application provider server receiving a merchandise link request signal for specific merchandise from the application distributor terminal, and linking merchandise for which a merchandise link request signal has been received to corresponding merchandise registered on the merchant site; and
(d) the affiliate application provider server sending information about the linked merchandise to the buyer terminal.

23. The Internet search engine affiliate method as set forth in claim 22, wherein the step (c) comprises the step (c1) of the affiliate application provider server receiving from the merchant site server related information of the merchandise for which the merchandise link request signal has been received, creating a link image that embodies features of the merchandise using the received related information, and sending the created link image to the application distributor terminal.

24. The Internet search engine affiliate method as set forth in claim 23, wherein the step (c) comprises, after the step (c1), the step (c2) of the affiliate application provider server, when a signal requesting a change of the link image is received from the application distributor terminal, creating a complete image obtained by changing the link image and sending the complete image to the application distributor terminal.

25. The Internet search engine affiliate method as set forth in claim 23, wherein the step (c1) comprises the step (c3) of the affiliate application provider server sending at least one recommended image similar to the created link image, together with the created link image, to the application distributor terminal.

26. The Internet search engine affiliate method as set forth in claim 23, wherein the step (c1) comprises:
the step (c4) of the affiliate application provider server, when appearance information of the merchandise for which the merchandise link request signal has been received does not exist in the affiliate application provider server, sending previously prepared link image creation information for the merchandise for which the merchandise link request signal has been received to the application distributor terminal; and
the step (c5) of the application distributor terminal creating a link image using the received link image creation information and sending the created link image to the affiliate application provider server.

27. An Internet search engine affiliate system, comprising:
at least one affiliate application provider server, the affiliate application provider server functioning as a server of a merchant site including a product sales website for providing an online space for sales or buying of one or more products over an Internet and an information sales website for providing paid information or at least one paid advertisement, the affiliate application provider server being provided with a database storing merchandise information of the merchant site, and the affiliate application provider server distributing at least one application, that is, software for performing an affiliate advertising function for merchandise, to at least one application distributor terminal over the Internet, and, when the application distributor terminal receives a search request signal for merchandise registered on the merchant site from at least one buyer terminal through the application, sending search result merchandise information in response to the search request signal to the buyer terminal through the application;
the buyer terminal for sending a search request signal for the merchandise registered on the merchant site to the affiliate application provider server through the application, and receiving and displaying search result merchandise information; and
the Internet for connecting the affiliate application provider server and the buyer terminal to each other.

28. An Internet search engine affiliate system, comprising:
a merchant site server, the merchant site server being a server of a merchant site including a product sales website for providing an online space for sales or buying of one or more products over an Internet and an information sales website for providing paid information or at least one paid advertisement, the merchant site server being provided with a database storing merchandise information of the merchant site;
at least one affiliate application provider server for distributing at least one application, that is, software for performing an affiliate advertising function for merchandise, to at least one application distributor terminal over the Internet, and, when a search request signal for merchandise registered on the merchant site is received from at least one buyer terminal through the application, sending search result merchandise information in response to the search request signal to the buyer terminal through the application;
the buyer terminal for sending a search request signal for the merchandise registered on the merchant site to the affiliate application provider server through the application, and receiving and displaying search result merchandise information; and
the Internet for connecting the merchant site server, the affiliate application provider server and the buyer terminal to each other.
